(19) United States
(12) Patent Application Publication
(10) Pub. No.: US 2021/0158298 A1
(43) Pub. Date: May 27, 2021

(54) CONTACT DISCOVERY LOAD BALANCING BY MATTER INVITE

(71) Applicant: Title Pipe, Inc., Eagle, ID (US)

(72) Inventor: Mark Rodeghiero, Star, ID (US)

(21) Appl. No.: 16/694,512

(22) Filed: Nov. 25, 2019

(51) Int. Cl. G06Q 10/10; H04L 29/06

(52) U.S. Cl. CPC G06Q 10/107; H04L 63/10

(57) ABSTRACT

Embodiments are disclosed for a “contact and matter management system” (CMMS) that standardizes contact discovery and matter asset management. The CMMS can load balance information gathering across matter participants by using matter invites, account for contact affiliation with organizations and relationships among contacts, and control and provide tools for contact inclusion and available actions in matters. The CMMS can facilitate invitations and authentications of previously known and unknown matter participants into a matter for various collaborations, such as to provide matter instructions and parameters, participant communication, document creation, sharing, or execution, etc. The CMMS can also manage relationships among contacts such as superior/subordinate relationships and can track contact roles, which can control the contacts' access to matter assets.

### TECHNICAL FIELD

The present disclosure is directed to a computerized contact and matter management system for distributing contact information discovery and managing matter asset access.

### BACKGROUND

Contact information and relationships between entities can be difficult to gather and update. Often contact databases contain information that is outdated, unconfirmed, or simply incorrect. These unreliable contact databases are relied upon in numerous industries, such as for medical records, real estate transactions, employee management, government administration, and many others. However, the errors in these databases compound when applied to matters that involve many disciplines working together and/or relationships between contacts. For example, there are often associations between the contacts and a structure of contacts within an organization that also need to be tracked, but this tracking can become increasingly difficult when contact errors exist.

In conventional contact management systems, parties to a matter such as a contract are left to manually enter contact information. This often includes painstakingly reaching out to potential parties to gather their information and enter it for the matter. This can devolve into a series of calls and emails to assistants and support staff, who may pass the request off to others—making the request two or three times removed from the original request. Each stage introduces additional opportunities for inaccuracy, failures in information security, and additional overhead for the requester to follow-up and record information. This results in matter participant discovery often taking days or weeks, with dubious results.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating components which, in some implementations, can be used in a system employing the disclosed technology.

FIG. 4 is a flow diagram illustrating a process used in some implementations for gathering contacts through matter invites and controlling access to matter assets.

FIG. 5 is a flow diagram illustrating a process used in some implementations for creating a contact with organization and inter-contact associations.

FIG. 6 is a conceptual diagram illustrating an example matter creation and management process using recursive participant invitations to gather contacts and control asset access.

The techniques introduced here may be better understood by referring to the following Detailed Description in conjunction with the accompanying drawings, in which like reference numerals indicate identical or functionally similar elements.

### DETAILED DESCRIPTION

Embodiments are disclosed for a “contact and matter management system” (CMMS) that standardizes contact discovery and matter asset management. The CMMS can load balance information gathering across matter participants by using matter invites, account for contact affiliation with organizations and relationships among contacts, control contact inclusion, and provide tools for matter participants to perform available actions. A “matter” can be various collaborations involving multiple parties such as transactions for real property, employment arrangements, commercial or private projects, etc. The CMMS can facilitate invitations and authentications of previously known and unknown matter participants into a matter for various collaborations, such as to provide matter instructions and parameters, participant communication, document creation, sharing, or execution, etc.

“Known” users can be users for which a contact already exists in the CMMS. In some cases, a contact can have an organization affiliation, one or more relationships to other contacts (e.g., a superior/subordinate relationship), and/or designated role(s) either that the contact can perform generally in matters or has been assigned in particular matters. The CMMS can allow known users to create a matter in the system and invite other known or unknown users to be matter participants. The CMMS can authenticate invited users into the system, e.g., verifying contact information, organizational affiliations, contact relationships, and/or roles. The CMMS can allow invited and authenticated contacts to access secured matter assets and to invite other previously known or unknown participants to the matter. This allows nth-degree unknown parties to be invited securely into a restricted matter environment inside of an electronic collaboration system, Profile information collected during the authentication and invite process provides dynamic contact information and updates, resulting in a real time self-administered repository of verified contact information.

In some cases, matter participants are invited to access only the assets (e.g., documents, instructions, databases, etc.) that correspond to their given role in the matter. Those invited into the matter can be authenticated (e.g., via phone and email authentication) and can additionally invite other known or unknown participants, who become known upon authentication. This process can iterate until no further invitations are sent or the available roles for the matter are all filled. As additional participants are authenticated, they gain access to assets, such as assets generally available to all participants or those assets assigned to their role.

In some embodiments, the CMMS can perform contact authentication using knowledge-based authentication, e.g., the user providing information that matches known information, which could be supplied by inviting matter participant of the user, or using a private key or two-factor authentication code to supply data matching a public key or known code for the user. In other embodiments, the authentication can be by physical authentication, e.g., location confirmation, in-person verification, etc. In yet further embodiments, the authentication can be communications based, e.g., proving the user has access to a device or account of the user, such as by providing a particular response or code for a text, phone call; or email.

When a user joins the CMMS, creating a contact; she can complete a profile to be part of the contact. In some cases, some or all of the profile information can come from the invite that was sent to the user; which in some cases the user may verify. In some implementations, a profile can contact can include an association with an organization and/or a relationship to other contacts. For example, a user can designate a particular organization and their role within that organization. The user can specify that their role includes oversite of other users. Each designated subordinate can be given the opportunity to accept the user as their superior, at which point the user is authenticated in a superior relationship with the subordinate. Similarly, when a new user joins the CMMS, she can designate a role in a selected organization and another user as a superior; automatically authenticating the superior/subordinate relationship with the new user.

Various embodiments of the CMMS described herein provide multiple improvements and benefits over both existing contact manager and project manager systems and techniques. These existing systems and techniques suffer from overloading a single contact gathering entity; contacts being created with inaccurate, second-hand information; days or weeks of delays in contact generation; contacts constantly becoming out of date; poor representation of verifiable relationships between contacts and organizations; and information security faults in both gathering contact data and providing access to matter assets. For example, existing systems have been prone to nefarious parties intercepting emails or other communications between matter participants, which they use to access sensitive matter information or alter matter parameters (e.g., funding instructions have been modified to redirect transfers). Furthermore, where existing systems have each organization relying on the validity of their own contact databases, matter information is frequently sent to incorrect parties or is delayed in reaching the appropriate party. For example, it is common for emails intended for a new employee of an organization to be mistakenly sent to a prior employee that had that role. These existing procedures do not allow for simultaneous discovery of unknown matter participant contact information and they do not incorporate a method for authenticating participants information.

The CMMS described herein overcomes these problems associated with existing contact manager and project manager systems through techniques rooted in computerized management which are not an analog to the traditional contact manager and project manager systems. In particular, the CMMS provides load balancing of contact management between matter participants by facilitating electronic invitations to the matter to be sent by both previously known and unknown participants. In addition, the CMMS ensures contact data integrity and accelerates contact data acquisition with unknown invited participants being prompted to create their own contact entries and automatic triggering known invited participants to update their contact entries. Furthermore, the CMMS provides data structures for assigning relationships between contacts, membership of contacts in organizations, and establishing roles for contacts at an organization or within matters, while providing procedures for users to verify these associations. Yet further, the CMMS provides information security in gathering contact data and controlling access to matter assets by providing a centralized repository with encryption and authentication for contacts, to which individual matter participants can extend access through invitations.

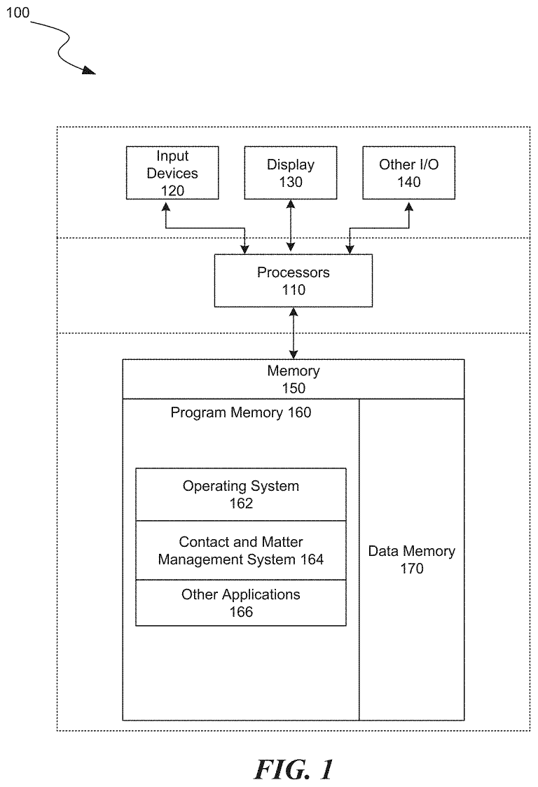

Several implementations are discussed below in more detail in reference to the figures. FIG. 1 is a block diagram illustrating an overview of devices on which some implementations of the disclosed technology can operate. The devices can comprise hardware components of a device 100 that can manage contact invitations and profile creation while administering matter asset access and other matter tools. Device 100 can include one or more input devices 120 that provide input to the Processor(s) 110 (e.g. CPU(s), GPU(s), HPU(s), etc.), notifying it of actions. The actions can be mediated by a hardware controller that interprets the signals received from the input device and communicates the information to the processors 110 using a communication protocol. Input devices 120 include, for example, a mouse, a keyboard, a touchscreen, an infrared sensor, a touchpad, a wearable input device, a camera- or image-based input device, a microphone, or other user input devices.

Processors 110 can be a single processing unit or multiple processing units in a device or distributed across multiple devices. Processors 110 can be coupled to other hardware devices, for example, with the use of a bus, such as a PCI bus or SCSI bus. The processors 110 can communicate with a hardware controller for devices, such as for a display 130. Display 130 can be used to display text and graphics. In some implementations, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The processors 110 can have access to a memory 150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, contact and matter management system 164, and other application programs 166. Memory 150 can also include data memory 170, e.g., invitation records, contacts data (e.g., one or more of: username, password, name, phone number, address, email, occupation, etc.), identifiers specifying contact roles, associations between contacts and organizations or between contacts, contact statuses (e.g., authenticated or not, whether contact details have been verified or were last verified); contact relationships to matters (e.g., indicators of which matters the contact is a participant of and/or what role the contact has in the matter), contact notification and communication history, configuration data, settings, user options or preferences, etc., which can be provided to the program memory 160 or any element of the device 100.

Some implementations can be operational with numerous other computing system environments or configurations. Examples of computing systems, environments; and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

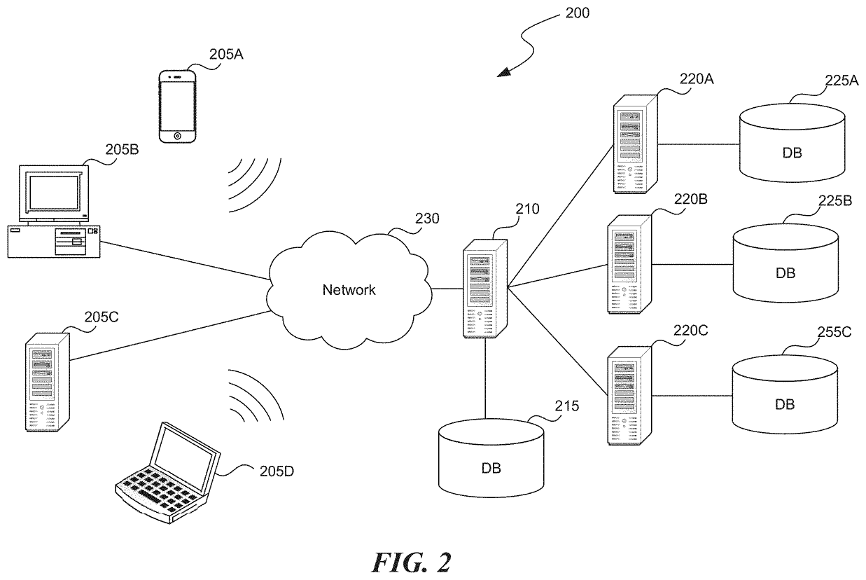

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g. store) information, e.g., invitation records, contacts data (e.g., one or more of: username, password, name, phone number, address, email, occupation, etc.), identifiers specifying contact roles, associations between contacts and organizations or between contacts, contact statuses (e.g., authenticated or not, whether contact details have been verified or were last verified), contact relationships to matters (e.g., indicators of which matters the contact is a participant of and/or what role the contact has in the matter), contact notification and communication history, configuration data, settings, user options or preferences, etc. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

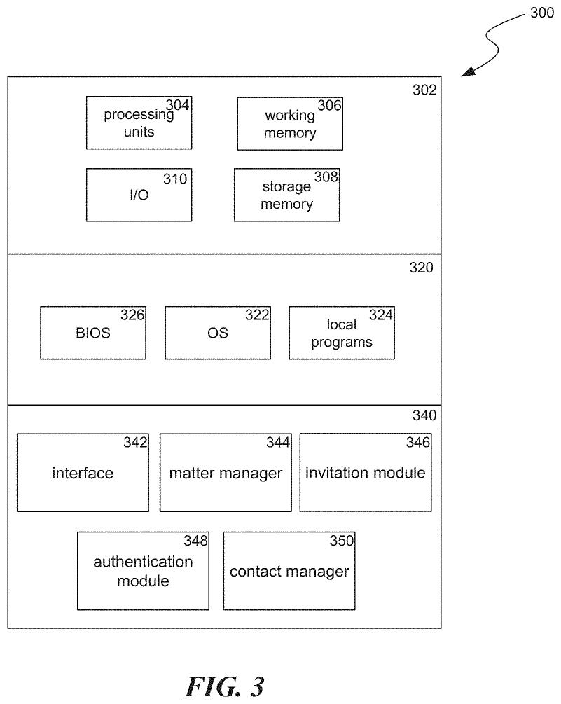

FIG. 3 is a block diagram illustrating components 300 which, in some implementations, can be used in a system employing the disclosed technology. The components 300 include hardware 302, general software 320, and specialized components 340. As discussed above, a system implementing the disclosed technology can use various hardware including processing units 304 (e.g. CPUs, GPUs, APUs, etc.), working memory 306, storage memory 308 (local storage or as an interface to remote storage, such as storage 215 or 225), and input and output devices 310. In various implementations, storage memory 308 can be one or more of: local devices, interfaces to remote storage devices, or combinations thereof. For example, storage memory 308 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 215 or storage provided through another server 220). Components 300 can be implemented in a client computing device such as client computing devices 205 or on a server computing device, such as server computing device 210 or 220.

General software 320 can include various applications including an operating system 322, local programs 324, and a basic input output system (BIOS) 326. Specialized components 340 can be subcomponents of a general software application 320, such as local programs 324. Specialized components 340 can include matter manager 344, invitation module 346, authentication module 348, contact manager 350, and components or APIs, such as interface 342, which can be used for providing user interfaces, transferring data, and controlling the specialized components. In some implementations, components 300 can be in a computing system that is distributed across multiple computing devices or can be an interface to a server-based application executing one or more of specialized components 340.

The matter manager 344 can allow known users to create and administer matters, e.g., by specifying matter roles, adding assets, administering asset access according to participant roles or credentials, providing communication tools, and other matter administration functions. Additional details on functions that the matter manager 344 can perform are provided below in relation to blocks 402 and 412-416.

The invitation module 346 can allow existing participants of a matter to invite other known and unknown users to that matter. Invitation module 346 can, in conjunction with authentication module 348 and matter manager 344, provide an interface for matter participants to send invitations or tokens for invitations to be sent outside the CMMS, notify those invited users, and authenticate those users upon their acceptance of an invitation. Additional details on functions that the invitation module 346 and authentication module 348 can perform are provided below in relation to blocks 404-408 and 418.

The contact manager 350 can create contacts for users and organizations and manage relationships between contacts. Following authentication by authentication module 348, contact creation can include transitioning unknown users into known users by creating a contact for the user, associating a profile with the new contact, and entering user details provided e.g., by the user, by an organization the user is associated with, or by another user that invited the new user. The contact manager 350 can manage which roles are assigned to each contact, e.g., based on user self-selection, selection by an associated organization, or based on a role assigned according to the matter invitation. The contact manager 350 can also associate contacts with organizations and can define relationships among organization members. For example, the contact manager can allow a user to designate who her superior in an organization is. As another example, the contact manager 350 can allow a user to designate one or more subordinates. In some implementations, the relationship is only confirmed when the designated subordinate verifies that she is a subordinate of the superior.

In some cases, the contact manager 350 is used after a matter is created and an unknown user has been invited to the matter and needs to have a contact to access the matter. Additional details on these functions of the contact manager 350 are provided below in relation to blocks 410, 502-506, and 516-528. In other cases, the contact manager 350 can be used iteratively as part of onboarding an organization, where a contact is created for each listed organization member. Additional details on these functions of the contact manager 350 are provided below in relation to blocks 508-530.

Those skilled in the art will appreciate that the components illustrated in FIGS. 1-3 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

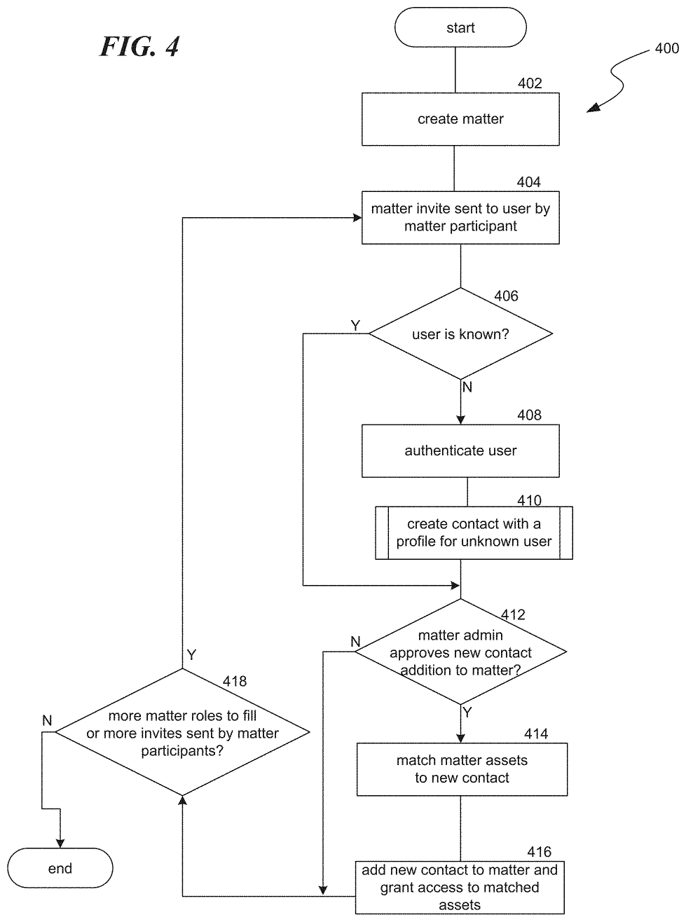

FIG. 4 is a flow diagram illustrating a process 400 used in some implementations for gathering contacts through matter invites and controlling access to matter assets. At block 402, process 400 can create a new matter. Creating a matter can include creating one or more records or database entries specifying features of the matter such as a name, type, available roles, limitations or rights for specified matter roles (e.g., matter asset access, user roles that can fill the matter roles, organizations that can participate in the roles or the matter as a whole, communication limitations or logging between roles, etc.), initial matter participants, tools that the CMMS can provide for matter participants, assets (e.g., documents or other media, instructions, etc.) for the matter, matter parameters (e.g., timelines/deadlines; properties indicated; encryption, asset transfer, or other security specifics; staring or ending conditions; project dependencies; etc.). In some implementations, any known user can create a matter. In other implementations, new matter creation can only be triggered by users with particular rights (e.g., administrators) or roles (e.g., organization supervisors or managers of a particular level). In some implementations, a new matter can have a specified administrator, e.g., the creating user or another designated user.

At block 404, process 400 can identify that a participant of the matter invited another user to the matter that was created at block 402. In some implementations, this can be a result of the inviting matter participant sending an invite through the CMMS. For example, the CMMS can include a form or tool for participants to provide emails, phone numbers, or other contact information, that the CMMS can use to invite other users to the matter. Such communication can be encrypted and secured. In other implementation, identifying an invitation can be the result of an invite recipient connecting with the CMMS through the invite (e.g., by activating a link in the invite) or providing a code or other identifier from the invite when accessing the CMMS. For example, the CMMS could provide invite codes or links with embedded identifiers to matter participants, which the participants can include in invite emails, over the phone, in a text or instant message, via social media, or another communication channel. The invited user can activate the link or visit a website provided by the CMMS and enter the code, causing the CMMS to identify the invite. When the invited user connects to the CMMS, the subsequent communication (e.g., via a web interface) can be encrypted and secured. In some implementations, as part of the invite, the inviting user can specify a role that the invited user will have in the matter and/or contact information for the invited user.

At block 406, process 400 can determine whether the identified invite is for a known or unknown user. For example, a user can respond to an invite by signing into the CMMS or creating a new contact with a profile. If the user signs into an existing account; they are a known user. As another example, a user identifier can be imbedded in the invite and the CMMS can determine whether the imbedded user identifier matches a user identifier for a known user in the CMMS. When the user is a known user, process 400 can proceed to block 412, otherwise process 400 can proceed to block 408. In some implementations, a known user may not have provided minimum profile information, may not have provided information needed to become a participant of the matter created at block 402, or information in the user's contact profile may have become outdated (e.g., hasn't been verified within a threshold timeframe). In these instances, even though the user may be known, process 400 continues to either block 408 or 410, to reauthenticate and/or update the user's contact profile.

At block 408, process 400 can authenticate the invited user. This can include knowledge-based authentication (e.g., the invited user providing information that matches known information about the invited user, which could be supplied by the inviting user, or using a private key to supply data matching a public key for the invited user), by physical authentication (e.g., location confirmation, in-person verification, etc.), and/or communications based authentication (e.g.; proving the invited user has access to a device or account of the user, such as by providing a particular response or code—e.g. two-factor authentication code—from a text, phone call, email or time-based code generator). For example, the invited user can be associated with a phone number or email address and the invited user can authenticate by providing an appropriate response to a text or call to the phone number or an email sent to the email address.

At block 410, process 400 can create a contact with a profile for the unknown user, or if the invited user is a known user, can update information in an existing profile for the contact of the known user. The new or updated profile can include information such as a username, password, name, nickname, phone number, address, email, occupation, roles, associations between contacts (e.g. other contacts identified as superiors or subordinates), organizations to which the user belongs, statuses (e.g., authenticated or not, whether contact details have been verified or were last verified), matters in which the contact is a participant and/or what role the contact has in the matter, contact notification status, logs of communications between contacts, etc. The profile can be stored as one or more files, one or more database records, one or more XML, JSON, or other data structures, or any other format suitable to associate data with data types or labels. In some implementations, a set of information can be requested from the user when they first create their profile. In some cases, additional information can be requested if the matter to which the user has been invited requires additional profile information. In some implementations, parts of the user data can be pre-populated from other sources such as a database of an organization the user is associated with, a social media profile of the user, partner databases that include the user, etc., and the user can verify the pre-populated data. Creating the contact with a profile can convert the unknown user to a known user. As indicated by the vertical lines on block 410, block 410 can include process 500 as a subprocess to create a contact with a profile or update a profile for an existing contact, starting at block 502.

At block 412, process 400 can determine whether an administrator for the matter created at block 402 approves adding the contact of the invited user to the matter. The administrator can be the matter creator or another designated user, which may or may not be a matter participant. In some cases, multiple users can have rights to approve the addition of a new contact to a matter. In some implementations, administrator approval is not required to add new contacts to a matter, in which case block 412 is skipped and block 414 is entered instead. If the administrator approves adding the new contact or no approval is needed, process 400 can continue to block 414. Otherwise, process 400 can continue to block 418.

At block 414, process 400 can match matter assets to the new contact. In some implementations, the matter can have assets assigned to particular roles, and the assets matched to the new contact can be those assigned to the role the new contact has generally or that she has within the matter. In various implementations, other factors can determine matched assets such as organization specific assets being matched to a contact based on organization membership(s), special assets being matched only to supervisors or subordinates, or general assets being matched to all matter participants. In some implementations, users can be assigned different rights with respect to different assets, e.g., depending on the above factors. For example, different users can have access to only read a document, while other users can also edit it or delete it.

At block 416, process 400 can make available, to the new contact, the assets matched at block 414. This can include setting flag or other variables for the new contact or checking matching characteristics each time the asset access relevant, such as when the user in control of the contact attempts to access an asset or a list of available assets is presented (e.g., in a website for the matter). In some implementations, asset access can be secured, e.g., preventing participants from downloading or otherwise removing the assets from the CMMS. In addition, communications between the participants and the CMMS, including accessing of assets, can be encrypted. It will be understood that granting access to a contact, as used herein, refers to giving the user associated with the contact the ability to access content, either directly through the contact or indirectly, e.g., via other credentials, file systems, repositories, etc.

At block 418, process 400 can continue back to block 404 if there are more roles in the matter to fill or if matter participants invite additional users (known or unknown) to the matter. Otherwise, process 400 ends.

An example execution of process 400 can be for a real estate transaction. A first user who is an escrow officer and a known user in the CMMS can create the real estate transaction matter at block 402, establishing himself as the matter administrator. The escrow officer can specify that the matter includes himself in the escrow officer role, and that there are listing agent, real estate seller, other open roles that matter participants invite. However, the escrow officer may only know who the listing agent is, so at block 404 he uses the CMMS to send an invite to that listing agent. The listing agent accepts by clicking a link and, having previously created a contact with a profile, signs into the CMMS as a known entity. Because the invited listing agent is known to the CMMS, process 400 proceeds to block 412. Since the invite was from an administrator of the matter, no further verification is needed and process 400 proceeds to block 414. The listing agent is then, at block 414, matched with documents assigned to the listing agent role which, at block 416, are made available to the listing agent. The listing agent is aware of the real estate seller and so sends a further invite to the real estate seller, causing process 400 to return to block 404 where the real estate seller clicks on a link in the real estate seller invite to join the matter. The real estate seller, however, is not known to the CMMS, so, from block 406, process 400 proceeds to block 408. The real estate seller is authenticated at block 408 by responding to a text message, proving the real estate seller has access to a phone with a number specified by the listing agent. The real estate seller then creates a contact with a profile at block 410. When the contact is created and the profile is complete, the escrow office (matter administrator) is notified and approves adding the real estate seller to the matter. The real estate seller is then matched to seller assets in the matter including documents added by the selling agent and tools allowing the real estate seller to communicate with the escrow officer and listing agent. This process can be repeated as any of the current matter participants invite additional users to the matter, e.g., for a real estate agent, a real estate buyer, a real estate lender, a real estate funder, etc.

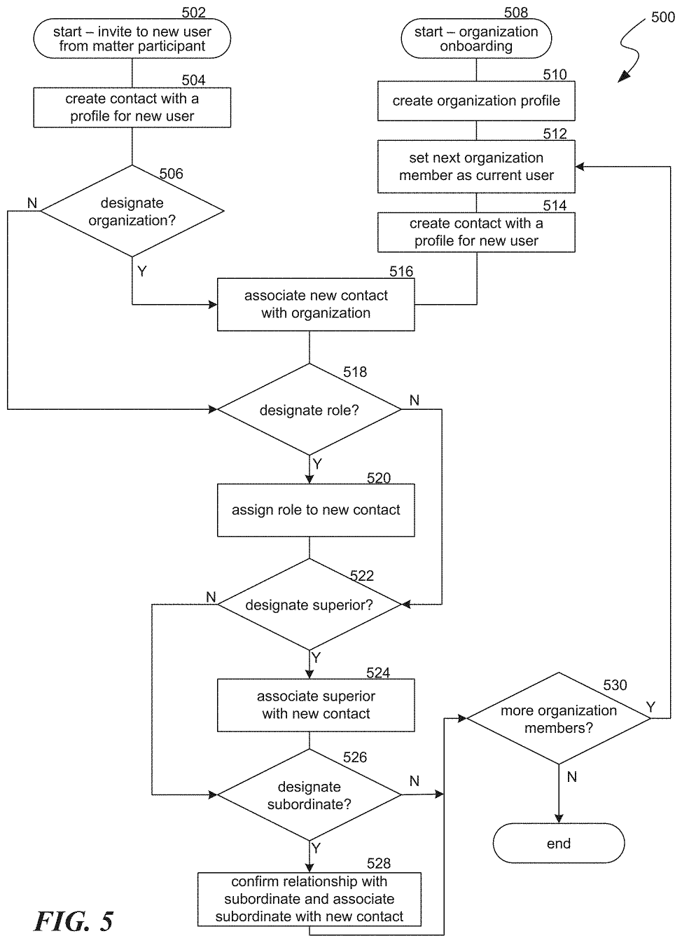

FIG. 5 is a flow diagram illustrating a process 500 used in some implementations for creating a contact, which can have a profile and organization and inter-contact associations. In some cases, process 500 can be a subprocess of process 400, as part of adding an unknown user to a matter, when initiated at block 502 by block 410. In some cases, process 500 can be performed during onboarding for an organization where process 500 creates contacts for one or more members of the organization, when initiated at block 508.

At block 504 from 502, process 500 can create a new contact with a profile for the previously unknown user, invited to the matter by a matter participant. The contact can be created as one or more database entries, a file, a data object, etc., which can include profile information the profile can be a separate entity associated with the contact, e.g., as additional database entries, files, data objects, etc. Profiles can include any type of user information such as handles (e.g., first name, last name, middle name, nickname, screenname, etc.), biographic info (e.g., eye color, complexion, height, weight, etc.), contact info (e.g., address, phone number, email, etc.), abilities, interests, or many others. In some implementations, the profile information can come from the user, from the invite to the user, or from third party systems, such as an organization HR database, a social media profile, etc. The communications to retrieve this user data can be encrypted and secured. In some implementations, the contact can be linked to other systems, such as social media systems, medical databases, real estate services, financial institutions, etc., to provide common login, shared and updated information, linked accounts, etc.

At block 506, process 500 can determine whether an organization is designated in association with the new contact. This designation could be specified by the matter participant in the invite or by the new user, e.g., as part of onboarding process provided when she first signs in following authentication. If an organization is designated, process 500 can obtain an existing organization profile for the organization and continue to block 516. If no contact for the organization exits, one can be created, e.g., with a profile including just the organization name or prompting the user for additional necessary organization details. If an organization is not designated, process 500 can continue to block 518.

As the remaining blocks of process 500 are the same whether process 500 begun at block 502 or 508, discussion will now turn to blocks 508-514 before returning to block 516. If process 500 is begun at block 508, it is part of an onboarding process for an organization to add a contact with a profile for the organization and one or more organization members associated with the organization. At block 510, process 500 can create the contact for the organization. In various implementations, the organization profile can include any information about an organization such as its name, legal status, positions, officers, mission, goals, organizational structure, relationship to other organizations, and innumerable others. Similarly to a contact, the organization entity can be created as database entries, a file, or other data structures.

As part of the onboarding process the organization can provide a list of organization members to onboard in the CMMS. At block 512, process 500 can set a next of the organization members as a current user or, if this is the first time that process 500 entered block 500 for this organization members list, process 500 can set the first organization member from the list as the current user.

At block 514, process 500 can create a new contact with a profile for the current user set at block 512. Creating the new contact can be accomplished in a manner similar to block 504. The profile information for the new contact can be included in the organization member list, can be retrieved from a database (e.g., the HR database) associated with the organization, or can be retrieved from the current user (e.g., when they next log into the system). In some implementations, the information can be gathered using a combination of these methods. For example, a basic name and email combination can be obtained from the organization members list, which the CMMS can fill into the profile and also use to send an invitation to the user to log into the system, at which point the CMMS can prompt the user to provide additional details for her contact.

At block 516, process 500 can associate the new contact with an organization. If the new contact was created at block 504, this will be the organization determined at block 506. If the new contact was created at block 514, this will be the organization profile created at block 510. In various implementations, this association can be in the form of a identifier added to one or both of the organization entity or the new contact, can be through a join table designating identifiers for both the organization and the new contact, by adding the new contact to a tree structure for the organization, or can be by creating some other virtual links or structure between the new contact and the organization. In some implementations, the association can include a position of the user for whom the contact is being created (e.g., officer, manager, group, team, etc.) within the organization.

At block 518, process 500 can determine whether a role is designated for the new contact, either by the user themselves, by an organization the user is associated with, or in an invite for the user to a matter. In some cases, the role assigned to a contact can vary for different matters. Roles can thus be specific to matters and are not retained by the contact when added to other matters. For example, when a user is invited to a matter she can be invited to fill a particular role in the matter. As another example, a user can be invited to a matter and can self-select an appropriate role for her contact upon being added. In some implementations, the self-selection can be limited by the role of the matter participant that sent the invitation, ensuring that they cannot add someone to the matter with greater access permissions than they have themselves. As a further example, when a user is invited to a matter, after authentication, their contact may be approved by a matter administrator who can assign or approve a designated role.

In other cases, the contact can be previously associated with one or more roles which will control which role the contact plays or can be assigned when being added to a matter. For example, a contact can be assigned a listing agent role, and when the contact is added to a matter the contact can automatically be assigned as the listing agent for that matter. As another example, a contact can be assigned roles as a pediatric nurse and an emergency nurse, and when added the CMMS will allow the contact to be assigned to either role (e.g., depending on the invite or user selection) but will not allow the contact to be assigned to a cardiac nurse role open in the matter.

In some implementations, roles can be designated as a sub-category of an organization, allowing the contact to be assigned a particular role within that organization. For example, a contact can be designated as operations manager in a first organization and as CEO in a second organization. In some implementations, role definitions can specify that the contact has oversite of other contacts in the same organization or can specify that the contact is a subordinate of another contact (contact hierarchies are discussed in greater detail below in relation to blocks 522-528).

If a role is designated for the new contact, process 500 can continue to block 520. Otherwise, process 500 can continue to block 522. At block 520, process 500 can assign, to the new contact, the role(s) determined as designated for the new contact at block 518. In various implementations, roles can be set for a contact e.g., by specifying one or more role values in an appropriate database field of the contact, by adding an entry to a join table, by specifying a property in a file or other data structure, etc. In cases where roles are assigned only for particular matters, but are not retained by the contact in other matters, this role association can include associating one or more contact identifiers with role designations for a matter. In cases where roles are retained by the contact, the role identifier can be associated with the contact. In cases where a contact's role is organization specific, the role can be a separately defined property or can be a sub-property of the property specifying the organization the contact belongs to.

At block 522, process 500 can determine whether the new contact has one or more designated superiors. In some implementations, a specified role can include a designation of being a superior. This can be part of a definition of the role provided through the organization or through a self-designation by the user when she added the role to the contact. In some implementations, superior/subordinate roles can be separate from role designations. For example, when the user creates a contact with a profile, the user can select one or more superiors (either from exiting contacts or by inviting a superior to join the CMMS). As another example, when onboarding an organization, the organization can provide an organization structure specifying a superior/subordinate tree. In some implementations, a superior designation can originate from another user joining the CMMS and specifying the new contact as one of her subordinates. The subordinate can then verify the other user as a superior designation, either upon creation of the new contact or, if the subordinate is a known member, at another point such as a next login. In this manner, superior/subordinate roles are automatically generated and verified. If a superior is designated, process 500 can continue to block 524, otherwise process 500 can continue to block 526.

At block 524, process 500 can associate each of the superiors determined as designated at block 522 with the new contact. In various implementations, superiors can be set for a contact e.g., by specifying one or more superior values in an appropriate database element for the contact, by adding an entry to a join table, by specifying a property in a file or other data object, by adding the contact to a tree or other data structure for an organization, etc.

At block 526, process 500 can determine whether the new contact has one or more designated subordinates. Similarly to superior designations, a specified role can include a designation of being a subordinate. This can be part of a definition of the role provided through the organization or through a self-designation when the role was added to the contact. In some implementations, superior/subordinate roles can be separate from role designations. For example, when the user creates a contact with a profile the user can select one or more subordinates (either from exiting contacts or by inviting a subordinate to join the CMMS). As another example, when onboarding an organization, the organization can provide an organization structure specifying a superior/subordinate tree. In some implementations, a subordinate designation can originate from another user joining the CMMS and specifying the new contact as one of her subordinates. The subordinate user can then verify the other user as a superior. If a subordinate is designated, process 500 can continue to block 528, otherwise process 500 can continue to block 530.

At block 528, process 500 can associate each of the subordinates determined as designated at block 526 with the new contact and mark the superior/subordinate relationship as confirmed. In various implementations, subordinates can be set for a contact e.g., by specifying one or more subordinate values in an appropriate database element for the contact, by adding an entry to a join table, by specifying a property in a file or other data object, by adding the contact to a tree or other data structure for an organization, etc. Once the subordinate has verified the subordinate relationship to the designated superior, the relationship can be marked as confirmed. In this manner, relationships can be both automatically established and confirmed. For example, when a new user identifies herself as a superior to one or more others, those relationship are only confirmed when each subordinate verifies that they are in-fact a subordinate of that superior.

At block 530, process 500 can determine whether there are additional organization members to onboard. If so, process 500 can return to block 512. If not, process 500 can end. If process 500 was initiated at block 502 for a single user, block 530 can be skipped and end instead.

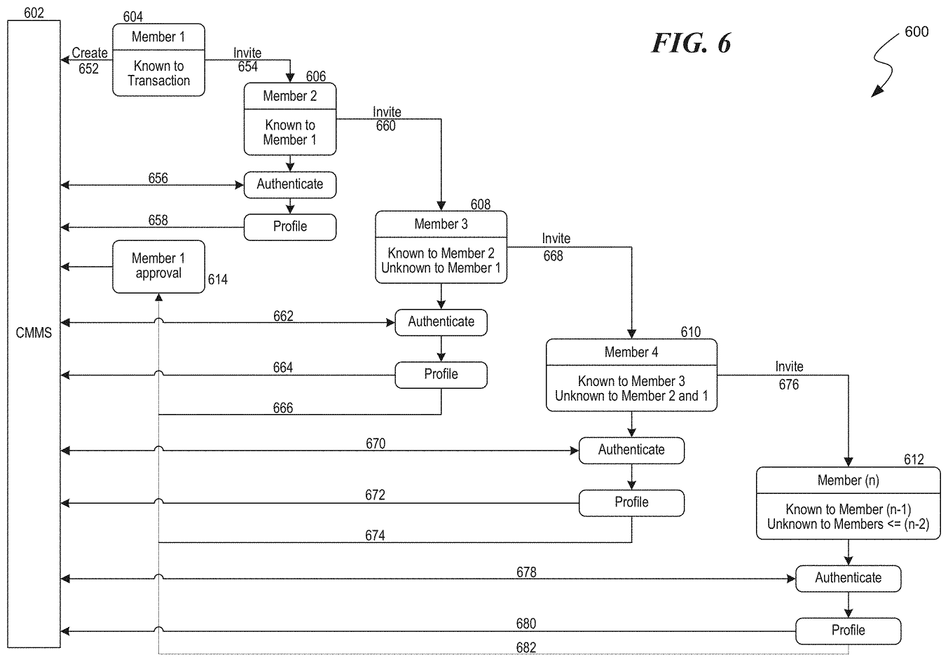

FIG. 6 is a conceptual diagram illustrating an example matter creation and management process 600 using recursive participant invitations to gather contacts and control asset access. Process 600 can be performed by an unlimited number of Members 1-n (604-612) interacting with contact and matter management system (CMMS) 602. Member 1 (604), as the administrator of a matter she created, can access via interaction with the CMMS 602, an approval dashboard 614 for approving contacts of users invited by other to a matter.

Process 600 begins with Member 1 (604), who is a known user already having a contact in the CMMS 602 with a profile, creating a matter at step 652, At step 654, Member 1 (604) sends an invite to the matter to Member 2 (606). Member 2 (606) performs an authentication by performing a telephone verification at step 656 with CMMS 602 and creates a contact and a profile at 658 with the CMMS 602. Member 2 (606) was invited by the matter by administrator Member 1 (604), and so the contact of Member 2 (606) does not need to be approved to be added to the matter.

At step 660, Member 2 (606) sends an invite to the matter to Member 3 (608). Member 3 (608) performs an authentication by performing an email verification at step 662 with CMMS 602 and creates a contact with a profile at 664 with the CMMS 602. The contact of Member 3 (608) is then approved by the matter administrator Member 1 (604), at step 666 to be added to the matter.

At step 668, Member 3 (608) sends an invite to the matter to Member 4 (610). Member 4 (610) performs an authentication by performing a text message verification at step 670 with CMMS 602 and creates a contact with a profile at 672 with the CMMS 602. The contact of Member 4 (610) is then approved by the matter administrator Member 1 (604), at step 674, causing the CMMS 602 to add the contact of Member 4 (610) to the matter.

This process can repeat any number of times until the nth Member 612 is invited, e.g., at step 676. The nth Member 612 performs an authentication at step 678 with CMMS 602 and creates a contact with a profile at 680 with the CMMS 602. The contact of the nth Member (612) is then approved by the matter administrator Member 1 (604), causing the CMMS 602 to add the contact of the nth Member (612) to the matter.

After each contact of the Members 2-n is approved by the matter administrator Member 1 (604), the CMMS 602 can match their role to a set of assets added by the matter administrator Member 1 (604) or other matter participants and grants them access to the matched assets. The CMS 602 can also provide matter guidelines or instructions, tools for communication or collaboration between the matter participants, applications or other services. In various implementations, the various members can be each a real estate agent, a real estate buyer, real estate lender, and/or a real estate funder.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for distributing contact discovery and managing matter asset access, the method comprising:
creating a matter in a matter management system;
identifying a first invitation, from one of one or more matter participants, to a first user previously associated in the matter management system with contact information;
adding a first contact of the first user as an additional one of the one or more matter participants;
identifying a second invitation, from the first user, to a second user not previously associated in the matter management system with contact information; and
adding a second contact of the second user as an additional one of the one or more matter participants, wherein adding the second user comprises:
obtaining approval from an administrator of the matter to add the second contact;
determining a role of the second contact in relation to the matter;
matching matter assets to the determined role; and
granting access, to the second user, for the matched matter assets.

2. The method of claim 1, wherein the adding the second contact further comprises creating the second contact upon the second user accessing the matter management system by:
prompting the second user for profile information; and
receiving a role designation for the second contact;
wherein the role designation is used in the determining of the role of the second contact in relation to the matter.

3. The method of claim 1, further comprising:
receiving a designation from the second user that the second user is a superior to one or more other users; and
receiving a verification, from each particular user of the one or more other users, that the second user is a superior to that particular user and, in response to each verification, designating a confirmed superior relationship of the second contact to a contact of the particular user.

4. The method of claim 1, further comprising:
receiving a designation from the second user that the second user s a subordinate to a third user; and
in response, designating a confirmed subordinate relationship of the second contact to a third contact for the third user.

5. The method of claim 4, further comprising:
receiving a designation from the second user that the second user is a member of an organization including the third user;
inviting the third user to the matter management system; and
associating the second contact and the third contact with the organization.

6. The method of claim 1,
wherein the second invitation included contact information for the second user; and
wherein the adding the second contact further includes authenticating the second user by sending, based on the contact information, a message to the second user and receiving proof, from the second user, that the second user received the message.

7. The method of claim 1; wherein the first user is previously associated in the matter management system with contact information resulting from a process including:
creating an organization profile for an organization; and
iteratively, for two or more organization members from a list of organization members:
creating a contact with a profile having information from a database associated with the organization;
associating the contact with the organization;
assigning a role to the contact based on the organization member's position in the organization;
identifying and assigning a superior for the contact;
identifying and assigning one or more subordinates for the contact; and
confirming, with one or more of the subordinates, that they are subordinates of the organization member.

8. The method of claim 1,
wherein the first user is a real estate agent;
wherein the second user is a real estate buyer;
wherein the method further comprises:
identifying a third invitation, from the real estate buyer, to a real estate lender not previously associated in the matter management system with contact information;
adding a contact of the real estate lender as an additional one of the one or more matter participants,
identifying a fourth invitation, from the real estate lender, to a real estate funder not previously associated in the matter management system with contact information; and
adding a contact of the real estate funder as an additional one of the one or more matter participants.

9. A computer-readable storage medium storing instructions that, when executed by a computing system, cause the computing system to perform operations for distributing contact discovery and managing matter asset access, the operations comprising:
identifying a first invitation, from one of one or more matter participants, to a first user previously associated in the matter management system with contact information;
adding a first contact of the first user as an additional one of the one or more matter participants;
identifying a second invitation, from the first user, to a second user not previously associated in the matter management system with contact information; and
adding a second contact of the second user as an additional one of the one or more matter participants;
wherein adding a particular contact of the first contact or the second contact as an additional one of the one or more matter participants comprises:
determining a role of the particular contact in relation to a matter;
matching matter assets to the determined role; and
granting access, to the particular contact, for the matched assets.

10. The computer-readable storage medium of claim 9, wherein the adding the second contact further comprises creating the second contact upon the second user accessing the matter management system by:
prompting the second user for profile information; and
receiving a role designation for the second contact;
wherein the role designation is used in the determining of the role of the second contact in relation to the matter.

11. The computer-readable storage medium of claim 9, wherein the operations further comprise:
receiving a designation from the second user that the second user is superior to one or more other users; and
receiving a verification, from each particular user of the one or more other users, that the second user is a superior to that particular user and, in response to each verification, designating a confirmed superior relationship of the second contact to a contact of the particular user.

12. The computer-readable storage medium of claim 9, wherein the operations further comprise:
receiving a designation from the second user that the second user is a subordinate to a third user; and
in response, designating a confirmed subordinate relationship of the second contact to a third contact for the third user.

13. The computer-readable storage medium of claim 12, wherein operations further comprise:
receiving a designation from the second user that the second user is a member of an organization including the third user;
inviting the third user to the matter management system; and
associating the second contact and the third contact with the organization.

14. The computer-readable storage medium of claim 9,
wherein the second invitation included contact information for the second user; and
wherein the adding the second contact further includes authenticating the second user by sending, based on the contact information, a message to the second user and receiving proof, from the second user, that the second user received the message.

15. The computer-readable storage medium of claim 9, wherein the first user is previously associated in the matter management system with contact information resulting from a process including:
creating an organization profile for an organization; and
iteratively, for two or more organization members from a list of organization members:
creating a contact with a profile having information from a database associated with the organization;
associating the contact with the organization;
assigning a role to the contact based on the organization member's position in the organization;
identifying and assigning a superior for the contact;
identifying and assigning one or more subordinates for the contact; and
confirming, with one or more of the subordinates, that they are subordinates of the organization member.

16. The computer-readable storage medium of claim 9,
wherein the operations further comprise:
identifying a third invitation, from the second user, to third user not previously associated in the matter management system with contact information;
adding a contact of the third user as an additional one of the one or more matter participants,
identifying a fourth invitation, from the third user, to a fourth user not previously associated in the matter management system with contact information; and
adding a contact of the fourth user as an additional one of the one or more matter participants;
wherein the first user, the second user, the third user, and the fourth user are each one of a real estate agent, a real estate buyer, real estate lender, or a real estate funder.

17. A computing system comprising:
one or more processors; and
a memory storing instructions that, when executed by the one or more processors, cause the computing system to perform operations comprising:
identifying a first invitation, from one of one or more matter participants, to a first user previously associated in the matter management system with contact information;
adding a contact of the first user as an additional one of the one or more matter participants;
identifying a second invitation, from the first user, to a second user not previously associated in the matter management system with contact information; and
adding a contact of the second user as an additional one of the one or more matter participants.

18. The computing system of claim 17, wherein the adding the contact of the second user comprises:
creating the contact for the second user upon the second user accessing the matter management system by:
prompting the second user for profile information; and
receiving a role designation for the second user;
matching matter assets to the role designation for the second user; and
granting access, to the second contact, for the matched assets.

19. The computing system of claim 17, wherein the adding the contact of the second user further comprises creating the contact of the second user upon the second user accessing the matter management system by:
receiving a designation from the second user that the second user is a superior to one or more other users; and
receiving a verification, from each particular user of the one or more other users, that the second user is a superior to that particular user and, in response to each verification, designating a confirmed superior relationship of the contact of the second user to a contact of the particular user.

20. The computing system of claim 17, wherein the first user is previously associated in the matter management system with contact information resulting from a process including:
creating an organization profile for an organization; and
iteratively, for two or more organization members from a list of organization members:
creating a contact with a profile having information from a database associated with the organization;
associating the contact with the organization;
assigning a role to the contact based on the organization member's position in the organization;
identifying and assigning a superior for the contact;
identifying and assigning one or more subordinates for the contact; and
confirming, with one or more of the subordinates, that they are subordinates of the organization member.
